(19) United States
(12) Patent Application Publication
(10) Pub. No.: US 2005/0081687 A1
(43) Pub. Date: Apr. 21, 2005

(54) Pliers with protected indicia on the handles

(76) Inventor: Bruce P. Konen, Aurora, IL (US)

Correspondence Address: Cook, Alex, McFarron,;Manzo, Cummings & Mehler, Ltd., Suite 2850, 200 West Adams Street, Chicago, IL, 60606, US

(21) Appl. No.: 10/688,449

(22) Filed: Oct. 17, 2003

(51) Int. Cl. B25B 7/00

(52) U.S. Cl. 81/427.5

(57) ABSTRACT

An indicia for demonstrating a particular type of two-handle hand tool, such as a pliers, is located on the protected inner surface of at least one of the handles. This location for the indicia provides for better viewing of the indicia when the tool is stored in a container and it protects the indicia from abrasion.

### BACKGROUND OF THE INVENTION

The present invention relates to hand tools and particularly to hand tools having an indicia or marking used to identify the particular type of tool. More specifically, the invention relates to indicia located on a protected surface of one or more handles of a hand tool having at least two handles. This positioning of the indicia allows recognition of the type of tool and prevents abrasion of the indicator.

Professional tradespeople such as electricians often carry a plurality of hand tools in a container such as a tool belt, tool pouch or tool carrier. Typically the tools are disposed in the container with a handle end of the tool protruding from the container and a head end or working end inserted into the container. Thus, the handle ends of the tools are exposed and visible while the head ends are concealed. Tools having different working ends often have the same or similar handle ends. For example, electricians may use linesman's pliers, needle nose pliers, standard pliers, slip joint pliers, wire cutters, crimpers and various styles of wire strippers, all of which have markedly different working ends but similar handle ends. When a plurality of tools of this type are stored in a tool belt, pouch or carrier with the handles extending therefrom, it becomes difficult to select the desired tool from among them without undue guesswork.

It is known to provide markers or indicia on a tool handle to indicate the type of tool head. U.S. Pat. No. 5,341,707 shows one example of how this can be done with screwdrivers and pliers. The primary approach in that patent is to apply the indicia on the butt end of the tool handle, although it also shows indicia on exposed sides of the handles of a pair of pliers. In this location the indicia are susceptible to wear and abrasion and they can be obscured by adjacent tools in the container.

### SUMMARY OF THE INVENTION

Therefore, there is a need for an identifier for tools that have more than one handle, which aptly indicates the type of tool without being susceptible to being abraded or covered up. In accordance with this need, the present invention overcomes the prior deficiencies by placing an indicia on a protected surface of at least one of the tool handles of a two-handle tool.

### BRIEF DESCRIPTION OF THE DRAWINGS

FIG. 1 is a perspective view of the handle portion of a linesman's pliers having an indicia on a protected surface of one handle.

FIG. 2 is a perspective view of the handle portion of a pliers according to the present invention placed in a container such as a tool belt.

### DETAILED DESCRIPTION OF THE INVENTION

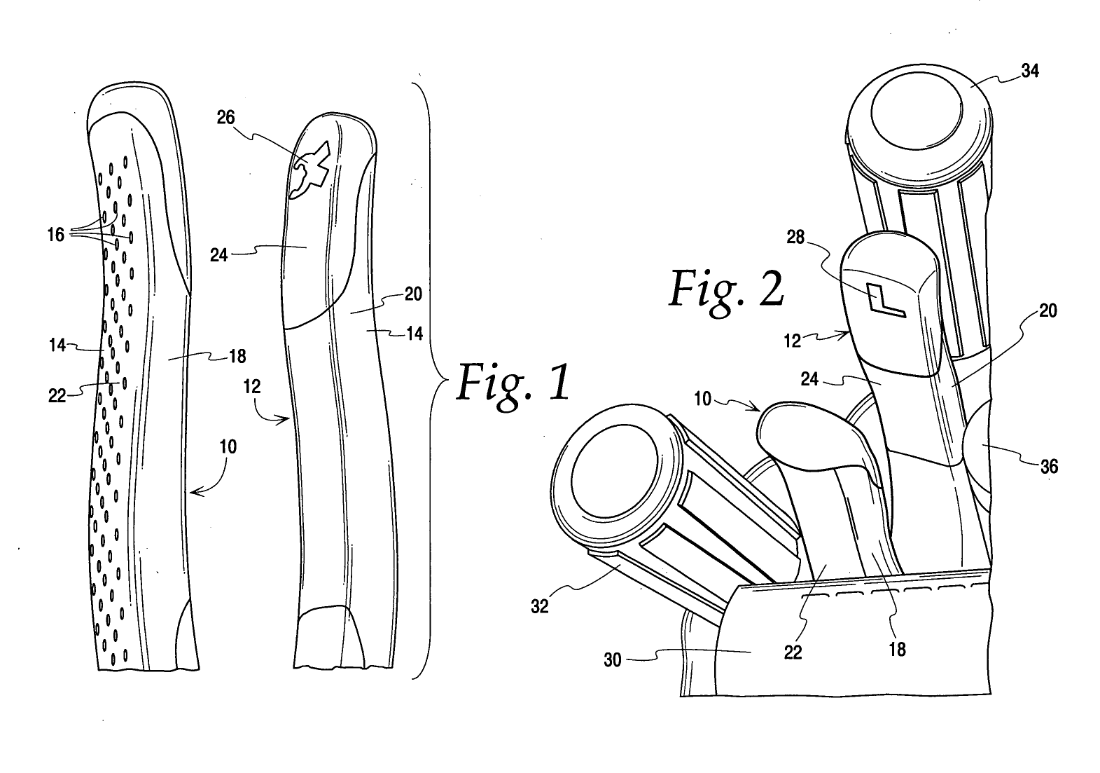

The handles of a linesman's pliers are shown in FIG. 1 at 10 and 12. Each handle in this embodiment includes a cushioned grip or sleeve 14. A plurality of indentations or dimples 16 may be formed in the sleeve to enhance the gripping characteristics of the sleeve. The handles are joined at a pivot (not shown) in the conventional manner. Beyond the pivot the handles each merge with a head end portion that has a suitable functional shape, again as is conventional.

Handle 10 has a first planar surface 18 while handle 12 has a similar first planar surface 20. These two surfaces are usually substantially coplanar. Although they are not visible in FIG. 1, it will be understood that each handle has a corresponding second planar surface. These second planar surfaces are also substantially coplanar and generally parallel to the first planar surfaces. The first and second planar surfaces are joined by an inner and outer surfaces. The outer surface 22 of the handle 10 is visible in FIG. 1, while the inner surface 24 of the handle 12 can also be seen in FIG. 1. It will be noted that the inner surfaces are in facing relation. Also, in normal, one-handed use of the tool the palm and fingers of a user's hand will wrap around and contact the first and second planar surfaces and the outer surfaces of the handles but they will not engage the inner surfaces. For this reason the inner surfaces will be referred to herein as protected surfaces. That is, since each inner face is protected by the facing presence of the opposite handle, the inner face is not subjected to wear or abrasion from a user's hands. Furthermore, the protected surface is less likely to have an adjacent tool in a container lodged right next to it.

An indicia or marking 26 is placed on at least one of the protected surfaces of the tool. The indicia can be formed in a variety of suitable ways. Examples are printing, painting, embossing, engraving, double shot molding or using a decal. The method of forming the indicia is not a part of the present invention. What is important is its location on the protected surface of the pliers. One form of the indicia is the graphical representation shown at 26 in FIG. 1. This representation can simulate the type of tool head formed on the other end of the tool. When a user looks into the tool container and sees the indicia 26, he or she will immediately recognize what type of tool each one is and thereby make the desired selection immediately.

An alternative indicia is shown at 28 in FIG. 2. This indicia is simply a letter indicating the type of pliers. In this case the letter “L” indicates this is a linesman's pliers. Sirnilar letter designations could be used for other types of pliers or wire stripper or what have you. FIG. 2 illustrates how the protected surface 24 tends to keep the indicia free from visual interference from other tools. Here the pliers is inserted head end down into a tool pouch 30. Other tool handles 32, 34 and 36 crowd around the pliers handles 10 and 12 but for the most part the protected surface 24 is shielded from these other tools. This maintains visibility of the indicia 28 despite the presence of immediately adjacent tools. The indicia is visible from several angles varying in degrees from perpendicular to the vertical plane of the tool's inner surface. It will be understood that if desired the indicia could be placed on one or both of the protected surfaces.

While a preferred form of the invention has been shown and described, it will be realized that alterations and modifications may be made thereto without departing from the scope of the following claims.

1. A hand tool having two bandies being pivotably connected to one another. each handle having first and second planar surfac es joined by inner and outer surfaces, said inner surfaces being the portions of said first and second handles facing each other, and indicia located on the inner surface of at least one of said handles and indicating the type of said tool.

2. The hand tool of claim 1 wherein said indicia is located on the inner surface of both of said handles.

3. The band tool of claim 1 further comprising a sleeve on at least one of said handles, and wherein the indicia is located on the portion of the sleeve that covers the inner surface of said handle.

4. The hand tool of claim 1 wherein the handles terminate in a tool head and the indicia indicates the size of the tool head.

5. The hand tool of claim 1 wherein the handles terminate in a tool head and the indicia indicates the type of the tool head.

6. A hand tool comprising first and second handle portions pivotably connected to one another, each handle terminating in a tool head portion, and an indicia located on a protected surface of at least one of said handles, said protected surface being the portion of each of said first and second handles facing each other.

7. The hand tool of claim 6 wherein indicia are located on a protected surface of more than one of said handles.

8. The hand tool of claim 6 wherein said indicia s integral with said handle.

9. The band tool of claim 6 further comprising a sleeve on each of said handles, wherein said indicia is located on one of said sleeves.

10. The hand tool of claim 9 wherein said indicia is integral with said sleeve.

11. A method of identifying a tool having at least two handle: being pivotably connected to one another, a tool head, and inner surfaces said inner surfaces being the portions of said first and second handles facing each other said method comprising the step of placing an indicia on the inner surface of at least one of said handles.

12. The method of claim 11 wherein said indicia indicates the type of said tool head.

13. The method of claim 11 wherein said indicia indicates the size of said tool head

14. The method of claim 11 wherein said indicia is integrally formed with said handles.

15. The method of claim 11 wherein said tool further comprises a sleeve, and wherein said indicia is integrally formed with said sleeve.
